(19) United States
(12) Patent Application Publication
(10) Pub. No.: US 2012/0326987 A1
(43) Pub. Date: Dec. 27, 2012

(54) LIGHT ACTUATOR FOR MOVABLE BUTTONS ON A KEYPAD

(75) Inventors: Gunnar Martin Fröjdh, Dalaro (SE); Carl Richard Henriksson, Stockholm (SE); Michael Lawrence Elyan, Drummoyne (AU); Thomas Eriksson, Stocksund (SE); Anders Jansson, Alta (SE); Joseph Shain, Rehovot (IL); Niklas Kvist, Varmdo (SE); Robert Pettersson, Hagersten (SE); Lars Sparf, Vallingby (SE); John Karlsson, Marsta (SE)

(73) Assignee: NEONODE, INC., Santa Clara, CA (US)

(21) Appl. No.: 13/602,217

(22) Filed: Sep. 3, 2012

Related U.S. Application Data
(63) Continuation-in-part of application No. 12/371,609, filed on Feb. 15, 2009.
Application No. 12/371,609 is a continuation-in-part of application No. 10/494,055, filed on Apr. 29, 2004, now Pat. No. 7,880,732.
Application No. 10/494,055 is a continuation-in-part of application No. 12/486,033, filed on Jun. 17, 2009.
Application No. 12/486,033 is a continuation-in-part of application No. 10/315,250, filed on Dec. 10, 2002, now Pat. No. 8,095,879.
Application No. 10/315,250 is a continuation-in-part of application No. 12/667,692, filed on Jan. 5, 2010.
Application No. 12/667,692 is a continuation-in-part of application No. 12/760,567, filed on Apr. 15, 2010.
Application No. 12/760,567 is a continuation-in-part of application No. 12/371,609, filed on Feb. 15, 2009.
Application No. 12/371,609 is a continuation-in-part of application No. 10/494,055, filed on Apr. 29, 2004, now Pat. No. 7,880,732.
Application No. 10/494,055 is a continuation-in-part of application No. 12/760,568, filed on Apr. 15, 2010.
Application No. 12/760,568 is a continuation-in-part of application No. 12/371,609, filed on Feb. 15, 2009.
Application No. 12/371,609 is a continuation-in-part of application No. 10/494,055, filed on Apr. 29, 2004, now Pat. No. 7,880,732.
(60) Provisional application No. 61/530,988, filed on Sep. 4, 2011.
(60) Provisional application No. 61/132,469, filed on Jun. 19, 2008.
(60) Provisional application No. 61/169,779, filed on Apr. 16, 2009.
(60) Provisional application No. 61/171,464, filed on Apr. 22, 2009.
(60) Provisional application No. 61/317,255, filed on Mar. 24, 2010.
(60) Provisional application No. 61/169,779, filed on Apr. 16, 2009.
(60) Provisional application No. 61/171,464, filed on Apr. 22, 2009.
(60) Provisional application No. 61/317,255, filed on Mar. 24, 2010.

(51) Int. Cl. G06F 3/02

(52) U.S. Cl. 345/168

(57) ABSTRACT

A keypad for use in conjunction with a touch-sensitive panel, the keypad including a frame surrounding a touch-sensitive panel, including a plurality of buttons suspended by the frame above the touch-sensitive panel, each of the buttons including a rigid member that is lowered through the frame when pressure is applied from above, and a resilient body attached to the rigid member and to the frame for raising the rigid member when the pressure from above is released, wherein the rigid members are exposed below the frame.

### CROSS REFERENCES TO RELATED APPLICATIONS

This application claims priority benefit of:
U.S. Provisional Application No. 61/530,988, entitled LIGHT ACTUATOR FOR MOVABLE BUTTONS ON A KEYPAD, filed on Sep. 4, 2011 by inventors Gunnar Fröjdh, Richard Henriksson, Michael Elyan, Magnus Goertz, Thomas Eriksson, Joseph Shain, Anders Jansson, Niklas Kvist, Robert Pettersson, Lars Sparf and John Karlsson;
U.S. application Ser. No. 12/371,609, entitled LIGHT-BASED TOUCH SCREEN, filed on Feb. 15, 2009 by inventors Magnus Goertz, Thomas Eriksson and Joseph Shain;
U.S. application Ser. No. 12/486,033, entitled USER INTERFACE FOR MOBILE COMPUTER UNIT, filed on Jun. 17, 2009 by inventors Magnus Goertz and Joseph Shain;
U.S. application Ser. No. 12/667,692, entitled SCANNING OF A TOUCH SCREEN, filed on Jan. 5, 2010 by inventor Magnus Goertz;
U.S. application Ser. No. 12/760,567, entitled OPTICAL TOUCH SCREEN SYSTEMS USING REFLECTED LIGHT, filed on Apr. 15, 2010 by inventors Magnus Goertz, Thomas Eriksson and Joseph Shain; and
U.S. application Ser. No. 12/760,568, entitled OPTICAL TOUCH SCREEN SYSTEMS USING WIDE LIGHT BEAMS, filed on Apr. 15, 2010 by inventors Magnus Goertz, Thomas Eriksson and Joseph Shain, all of the contents of which are hereby incorporated by reference.

### FIELD OF THE INVENTION

The field of the present invention is user input devices.

### BACKGROUND OF THE INVENTION

Many consumer electronic devices are now being built with touch-sensitive screens, for use with finger or stylus touch user inputs. However, for many users physical buttons are desirable. Many individuals appreciate the user experience of depressing a physical button rather than tapping a virtual button in a screen. Although haptic touch responses provide a form of feedback to touch screen input, they are not the same as depressing a button.

Blind people can feel raised braille indicia on a physical button, but cannot easily distinguish different virtual buttons displayed on a touch screen.

In some cases an input device needs to be protected from the environment. For example, a user input device to be used at sea or outdoors in inclement weather may become wet. Liquid poured onto an input device can interfere with the input mechanism.

### SUMMARY OF THE DESCRIPTION

The present invention addresses many of the known shortcomings of both physical input keypads and touch screens, by enabling button keypad input using a touch-sensitive surface. Additional benefits, such as reduced cost and efficient reuse of a single input device will become evident as the invention is described.

Aspects of the present invention provide a removable keypad chassis that is placed on top of a light-based touch-sensitive surface. The user enters data by depressing the keypad keys. A depressed key is detected by the touch-sensitive surface beneath the chassis. A calculating unit determines the location of the depressed key on the touch surface and maps the corresponding keypad key. The calculating unit sends input corresponding to the depressed key to a host system.

The light-based touch-sensitive surface upon which the keypad chassis is placed, displays key icons. Users can touch the icons to enter input or place the chassis over the icon area and enter the same input by depressing the corresponding keypad keys. Preferably, the touch-sensitive surface is a section of a panel that includes a touch-sensitive display. Optical elements, emitters and receivers are arranged around the panel to detect touches and determine touch locations on the panel. The keypad chassis is preferably affixed in a preferred position over the panel by inserting four legs extending from the chassis into respective cavities in the panel housing. This ensures that the keypad buttons are properly aligned with their corresponding virtual buttons on the touch surface.

There is thus provided in accordance with an embodiment of the present invention a keypad for use in conjunction with a touch-sensitive panel, the keypad including a frame surrounding a touch-sensitive panel, including a plurality of buttons suspended by the frame above the touch-sensitive panel, each of the buttons including a rigid member that is lowered through the frame when pressure is applied from above, and a resilient body attached to the rigid member and to the frame for raising the rigid member when the pressure from above is released, wherein the rigid members are exposed below the frame.

There is additionally provided in accordance with an embodiment of the present invention a keypad input system including a housing, a touch-sensitive panel exposed along an outer surface of the housing, a frame for temporary placement around the touch-sensitive panel on the outer surface of the housing, including a plurality of buttons suspended by the frame above the touch-sensitive panel, each of the buttons including a rigid member that is lowered through the frame onto the touch-sensitive panel when pressure is applied to the button from above, and a resilient body attached to the rigid member and to the frame for raising the rigid member when the pressure applied to the button from above is released, and a processor in the housing connected to the touch-sensitive panel, for processing touch input to the panel in accordance with the buttons to generate keypad input.

### BRIEF DESCRIPTION OF THE DRAWINGS

The present invention will be more fully understood and appreciated from the following detailed description, taken in conjunction with the drawings in which:

FIG. 1 is a simplified illustration of a touch panel featuring a display portion, a virtual keypad portion and a removable keypad, for incorporation into a housing such as a multi-function peripheral (MFP) housing, in accordance with an embodiment of the present invention;

FIG. 2 is a simplified illustration of three views of an exemplary four-button keypad chassis, situated over a virtual keypad portion of a touch panel, in accordance with an embodiment of the present invention;

FIG. 3 is a simplified illustration of a cross-section of an exemplary four-button keypad chassis, situated over a virtual keypad portion of a touch panel, in accordance with an embodiment of the present invention;

FIG. 4 is a simplified illustration of a spring-resilient key that is released and depressed, in accordance with an embodiment of the present invention;

FIG. 5 is a simplified illustration of a cross-section of a key comprised of an elastic, resilient material such as rubber, in accordance with an embodiment of the present;

FIG. 6 is a simplified illustration of an alternative button configuration, in accordance with an embodiment of the present invention;

FIG. 7 is a simplified flow diagram of a method for configuring a touchpad to match the configuration of an inserted keypad, in accordance with an embodiment of the present invention;

FIG. 8 is a simplified illustration of the underside of a keypad chassis with an embedded RFID chip, in accordance with an embodiment of the present invention;

FIG. 9 is a simplified illustration of the undersides of three keypad chasses having extensions used to distinguish between the keypads, in accordance with an embodiment of the present invention;

FIG. 10 is a simplified illustration of a keypad chassis with magnetic ball fasteners for securing the chassis in place on a touch panel, in accordance with an embodiment of the present invention; and

FIG. 11 is a simplified illustration of a keypad chassis with flexible hook fasteners for snapping the chassis in place on a touch panel, in accordance with an embodiment of the present invention.

### DETAILED DESCRIPTION

Aspects of the present invention relate to removable keypads for use with light based touch panels. Embodiments of the present invention provide a keypad chassis that is easily inserted and removed by a user over a light-based touch panel.

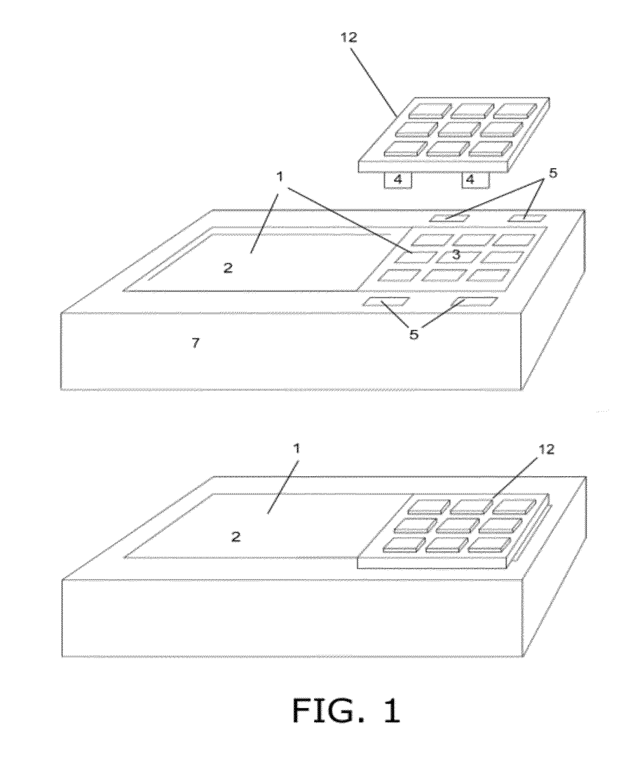

Reference is made to FIG. 1, which is a simplified illustration of a touch panel featuring a display portion, a virtual keypad portion and a removable keypad, for incorporation into a housing such as a multi-function peripheral (MFP) housing, in accordance with an embodiment of the present invention. MFP typically provides printing, copying and scanning in a single device. As shown in FIG. 1, a touch panel 1 includes a display portion 2 and a touch pad portion 3. MFP jobs are configured through user input on the touch pad portion of the panel. The display portion of the panel presents job status information and various options, such as number of copies, paper source, and single or double-sided printing. Some functions are configured by user touch interaction with graphical elements on the display portion of the panel. These elements are generated dynamically and provide different sets of options for different job contexts. For instance, an initial screen provides three buttons for selecting whether to copy, scan or fax. When a user selects one option, various options for the selected job are presented, such as selecting a number of copies in a copy job, a fax number for a fax job, or a file name and folder location for storing a scanned document. However, certain fixed functionality is provided by the touch pad in order to allow blind individuals to use the MFP by pressing buttons with braille keys. The present invention teaches a removable keypad that can be easily inserted, used and removed by a blind user.

FIG. 1 shows touch panel 1 in housing 7 and removable keypad 12. In the upper portion of the figure removable keypad 12 is above panel 1, and in the lower portion of the figure removable keypad 12 is affixed to panel 1 over touch pad portion 3, by inserting keypad fastener pegs 4 into panel housing cavities 5.

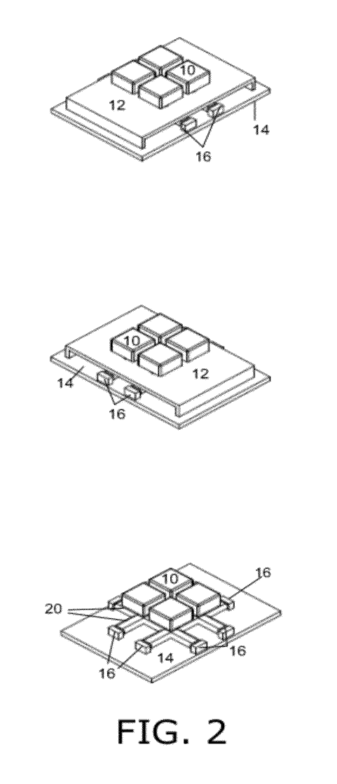

Reference is made to FIG. 2, which is a simplified illustration of three views of an exemplary four-button keypad chassis, situated over a virtual keypad portion of a touch panel, in accordance with an embodiment of the present invention. FIG. 2 shows keys 10 in removable chassis 12. Touch panel 14 is situated beneath chassis 12. Emitters and receivers 16 are shown as part of touch panel 14. Emitters and receivers 16 are placed beneath surface 14 but are shown above the screen in FIG. 2 in order to clearly indicate touch detection light beams 20.

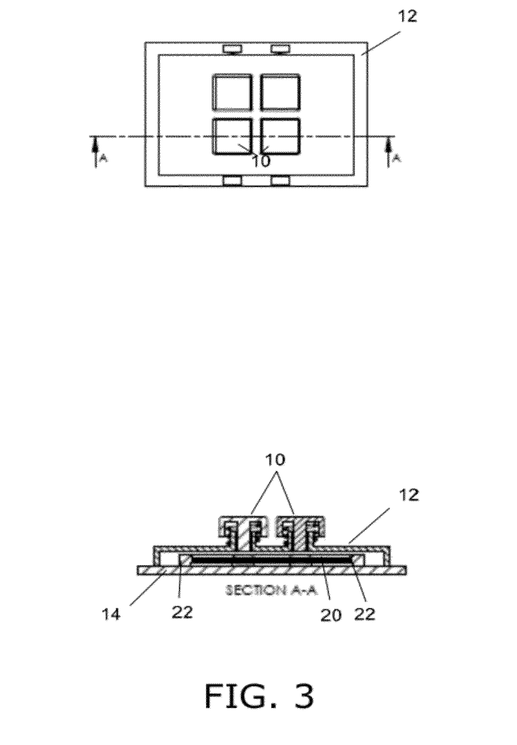

Reference is made to FIG. 3, which is a simplified illustration of a cross-section A-A of an exemplary four-button keypad chassis, situated over a virtual keypad portion of a touch panel, in accordance with an embodiment of the present invention. FIG. 3 shows keys 10 in removable chassis 12. Touch panel 14 is situated beneath chassis 12. Emitter and receiver lenses 22 are shown with touch detection light beam 20 above the surface of touch panel 14.

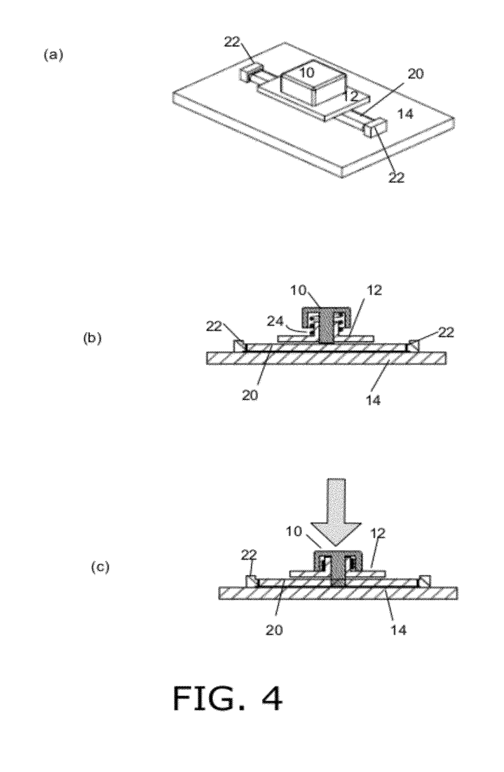

Reference is made to FIG. 4, which is a simplified illustration of a spring-resilient key that is released and depressed, in accordance with an embodiment of the present invention. FIG. 4(a) shows key 10 in a portion of removable chassis 12. Touch panel 14 is situated beneath chassis 12. Emitter and receiver lenses 22 are shown with touch detection light beams 20 above the surface of touch panel 14.

FIG. 4(b) is a cutaway of button 10 showing spring mechanism 24 for maintaining button 10 upward in chassis 12 and above light beam 20. FIG. 4(c) is a cutaway of button 10 showing spring mechanism 24 being compressed by downward pressure exerted by a user pressing button 10. In this case, the bottom of button 10 is lowered to block light beam 20. When the user releases this downward pressure, spring 24 returns button 10 to its position in FIG. 4(b).

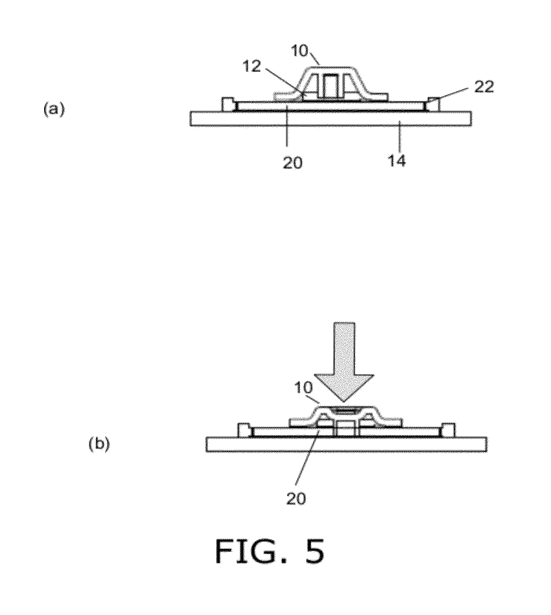

Reference is made to FIG. 5, which is a simplified illustration of a cross-section of a button made of an elastic, resilient material such as rubber, in accordance with an embodiment of the present invention. FIG. 5(a) is a cutaway of elastic button 10 upward in chassis 12 and above light beam 20 projected through emitter and receiver lenses 22 over and across touch panel 14.

FIG. 5(b) is a cutaway showing button 10 being depressed by downward pressure exerted by a user pressing button 10. In this case, the bottom of button 10 is lowered to block light beam 20. When the user releases his downward pressure button 10 returns to its position in FIG. 5(a) due to its resilient and elastic properties.

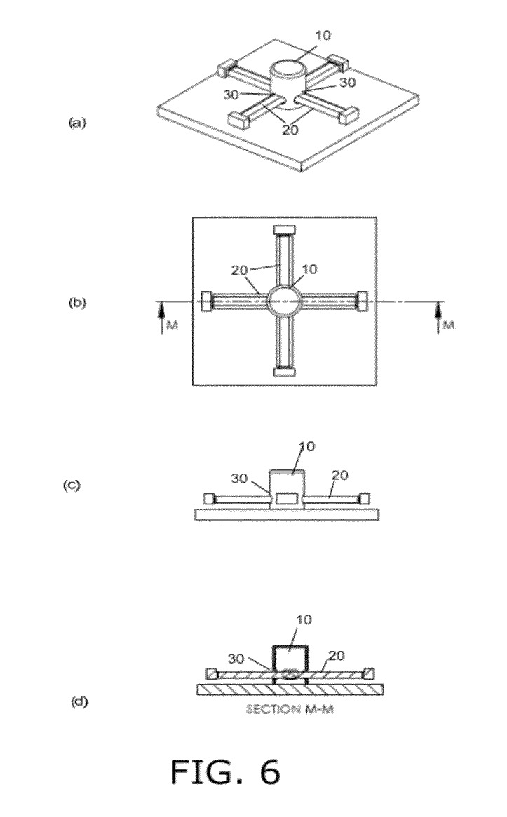

Reference is made to FIG. 6, which is a simplified illustration of an alternative button configuration, in accordance with an embodiment of the present invention. Button 10 of FIG. 6 has two intersecting cavities 30 through its trunk that allows light beams 20 to pass. When button 10 is depressed, the cavity is lowered and a solid portion of the trunk blocks the light beams.

FIG. 6(a) is a 3-D view of the button. FIG. 6(b) is a top view of the button, and FIG. 6(c) is a side view of the button. FIG. 6(d) is a cross section along line M-M of the button. Button 10 of FIG. 6 is maintained in its upward position using either the spring loaded embodiment of FIG. 4 or the resilient material embodiment of FIG. 5.

The removable keypad chassis was described above as having the same keypad layout as the touchpad onto which it is placed. According to other embodiments, the chassis has different keys and/or a different layout than the underlying touchpad. For example, three dedicated keypads are provided: one for copying, one for faxing and one for scanning. Each dedicated keypad has keys relevant for their respective tasks and some keypads have more keys than others. For example, a fax keypad has a numeric keypad for entering a phone number only, and a scan keypad has a full QWERTY keypad for entering a filename. In addition, dedicated keys are provided for each dedicated keypad, such as “send” for faxes, or “no. of copies” for a copier.

In accordance with an embodiment of the present invention, the keypads are identified using RFID technology. Each dedicated keypad has an RFID or similar digital code that is read by the MFP when the keypad is inserted into the MFP panel. The MFP configures itself to interpret the touch input generated by the keypad according to the layout of the keypad. The MFP also enters the appropriate mode: copy, fax or scan, based on the RFID or similar digital code that is read by the MFP when the keypad is inserted into the MFP panel. Each dedicated keypad has a braille label to facilitate a blind user's selecting a desired keypad.

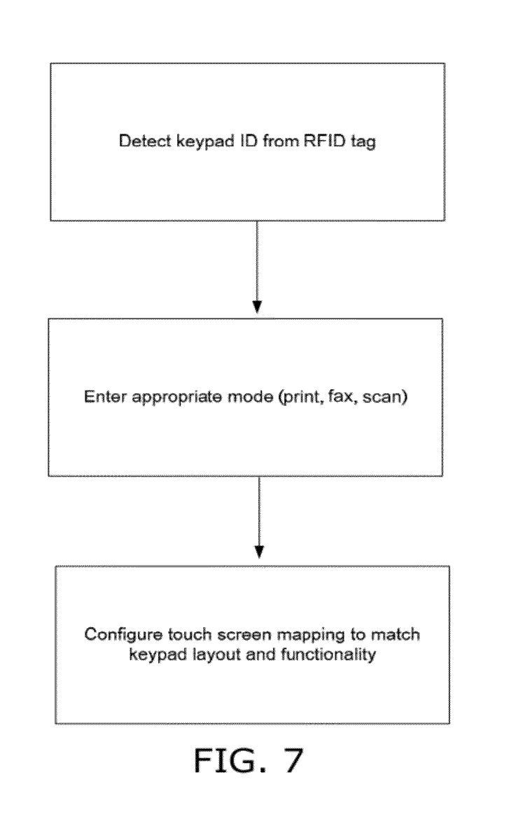

Reference is made to FIG. 7, which is a simplified flow diagram of a method for configuring a touchpad to match the configuration of an inserted keypad, in accordance with an embodiment of the present invention. An RFID tag on the keypad is detected by the MFP when the keypad is inserted above the MFP touchpad, due to the RFID proximity with a sensor situated inside the MFP housing near the touch panel. As a result the MFP enters an appropriate mode (print, fax, scan) and maps the touch panel surface according to the layout and functionality of the detected keypad.

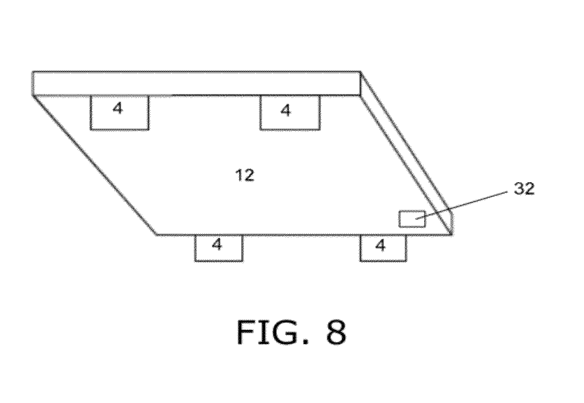

Reference is made to FIG. 8, which is a simplified illustration of the underside of keypad chassis 12 with embedded RFID chip 32, in accordance with an embodiment of the present invention.

Chassis 12 is shown with legs 4 that extend into securing cavities in the printer panel housing. According to other embodiments, the chassis has 2-4 shallow magnetic domes on the chassis underside to be magnetically fastened to respective, shallow magnetic wells around the panel housing. This enables easy and secure fastening without making noticeable holes in the panel housing, and gives the chassis a slim profile.

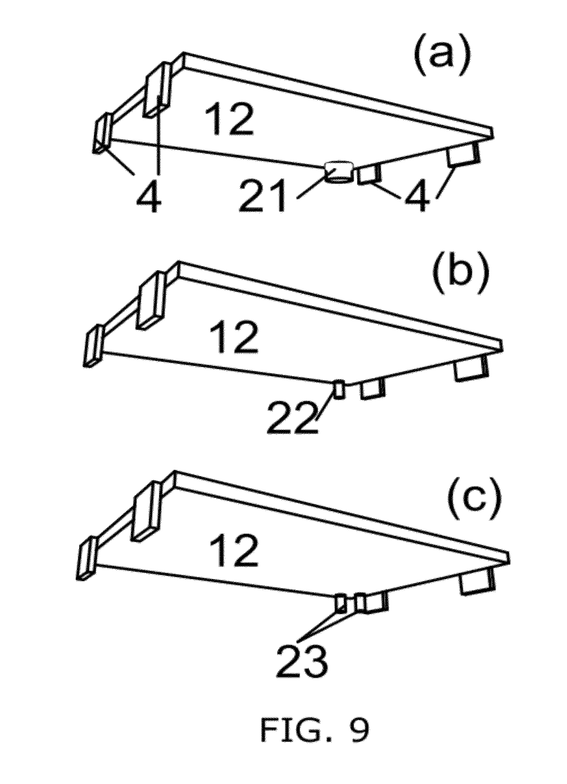

In accordance with other embodiments of the present invention, each keypad is identified by a unique contact pattern with the touch panel. Reference is made to FIG. 9, which is a simplified illustration of the undersides of three keypad chasses 12 having extensions used to distinguish between the keypads, in accordance with an embodiment of the present invention. Each chassis 12 has a unique extension in one corner of the panel, in addition to the four legs 4 described hereinabove. FIG. 9 shows (a) a wide cylinder extension 21, (b) a narrow cylinder extension 22, and (c) a pair of narrow cylindrical extensions of prongs 23. The touch sensitive surface is operable to detect the contact area of a touch, and to thereby distinguish between a large contact area, as in (a), and a small contact area, as in (b); and to detect two touches separated by a space, as in (c), based on the pattern of blocked light beams created by the touch object. Extensions 21, 22 and 23 are preferably placed at a location on chassis 12 that does not block light beams used to detect depressed keypad buttons. As such, these extensions are shown in FIG. 9 at far corners of chassis 12.

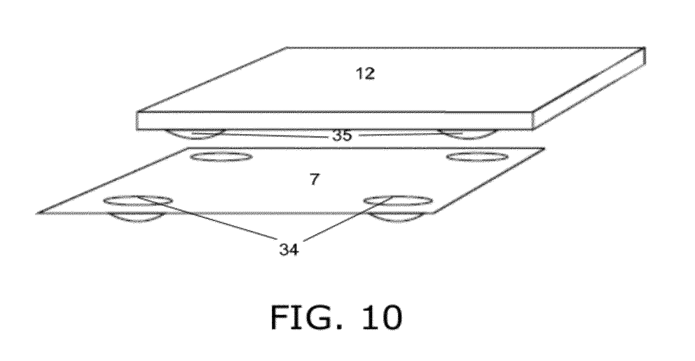

Reference is made to FIG. 10, which is a simplified illustration of a keypad chassis with magnetic ball fasteners for securing the chassis in place on a touch panel, in accordance with an embodiment of the present invention. As shown in FIG. 10, magnetic domes 35 on the underside of keypad chassis 12 fit into magnetic wells 34 in panel housing 7.

The removable keypad taught by the present invention is also usable with tablet computers such as the IPAD®, and with touchscreen phones. In these cases an application running on the computer or phone presents a keypad in the bottom portion of the device's touch screen, and entered text is displayed in an upper portion of the screen. The keypad chassis is configured according to the target device dimensions. In one embodiment the chassis is affixed to the device with semi-rigid hooks on two or three edges of the chassis that conform to the device edges. The hooks fit securely around these edges so that the chassis can be slid onto the device. Alternatively, the semi-rigid material of the hooks allows a user to snap the chassis onto the device as the hooks resiliently bend around the device when the chassis is pressed onto the front of the device.

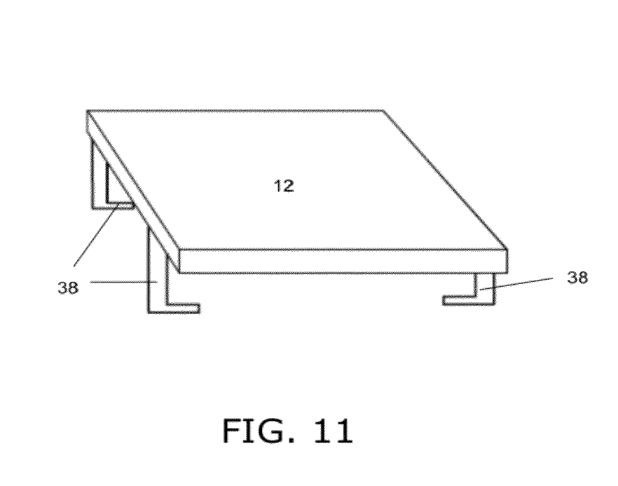

Reference is made to FIG. 11, which is a simplified illustration of a keypad chassis with flexible hook fasteners for snapping the chassis in place on a touch panel, in accordance with an embodiment of the present invention. As shown in FIG. 11, flexible semi-rigid hooks 38 extend from two sides of keypad chassis 12 for grabbing onto a tablet or other device housing.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A keypad for use in conjunction with a touch-sensitive panel, the keypad comprising:
a frame surrounding a touch-sensitive panel, comprising a plurality of buttons suspended by the frame above the touch-sensitive panel, each of said buttons comprising:
a rigid member that is lowered through the frame when pressure is applied from above; and
a resilient body attached to said rigid member and to said frame for raising said rigid member when the pressure from above is released,
wherein said rigid members are exposed below the frame.

2. The keypad of claim 1, wherein the underside of said frame comprises at least one magnetic ball fastener for insertion into a corresponding magnetic concave socket in a housing for the touch-sensitive panel, for aligning said frame above the panel.

3. The keypad of claim 1, wherein the underside of said frame comprises a plurality of legs for insertion into a corresponding plurality of cavities in a housing for the touch-sensitive panel, for aligning said frame above the panel.

4. The keypad of claim 1, wherein the underside of said frame comprises a plurality of clip fasteners to releasably grip a housing for the touch-sensitive panel, for securing said frame above the panel.

5. The keypad of claim 1, wherein said rigid member of each button is pierced by a hole through which light beams projected above and across the touch-sensitive panel are transmitted.

6. The keypad of claim 1, further comprising an RFID chip for communicating characteristics of said frame to a processor connected to the panel, for processing touch input to the touch-sensitive panel in accordance with said buttons.

7. The keypad of claim 1, wherein said frame is a silicon frame.

8. The keypad of claim 1, wherein each of said buttons comprises braille indicia.

9. The keypad of claim 1, further comprising a stationary extension beneath said frame for identifying said frame based on characteristics of the extension, as detected by the touch sensitive panel.

10. The keypad of claim 9, wherein the characteristics of the extension comprise a size of the extension.

11. The keypad of claim 9, wherein said extension comprises multiple prongs, and wherein the characteristics of the extension comprise the number of said prongs.

12. A keypad input system comprising
a housing;
a touch-sensitive panel exposed along an outer surface of said housing;
a frame for temporary placement around said touch-sensitive panel on the outer surface of said housing, comprising a plurality of buttons suspended by the frame above said touch-sensitive panel, each of said buttons comprising:
a rigid member that is lowered through the frame onto said touch-sensitive panel when pressure is applied to the button from above; and
a resilient body attached to said rigid member and to said frame for raising said rigid member when the pressure applied to the button from above is released; and
a processor in said housing connected to said touch-sensitive panel, for processing touch input to the panel in accordance with said buttons to generate keypad input.

13. The keypad input system of claim 12, wherein said touch-sensitive panel is responsive to finger touches and, when uncovered, displays a keypad image similar in appearance to said plurality of buttons in said frame, and wherein said processor processes finger touches on said touch-sensitive panel to generate keypad input.

14. The keypad input system of claim 12, wherein the outer surface of said housing comprises at least one magnetic well near said panel, and wherein said frame comprises at least one magnetic ball fastener for insertion into said at least one magnetic well in order to align said frame above said touch-sensitive panel.

15. The keypad input system of claim 12, wherein said touch-sensitive panel comprises:
a plurality of light emitters that project light beams over and across said touch-sensitive panel;
a plurality of light receivers that detect the projected light beams, and
a processor connected to said light receivers, for determining which of said buttons is being pressed based on an absence of an expected one or more of the projected light beams due to blockage by a lowered rigid member of one of said buttons.

16. The keypad input system of claim 12, further comprising a touchscreen electronic display in said housing.

17. The keypad input system of claim 12, wherein said touch screen panel is an electronic display.

18. The keypad input system of claim 12, wherein said frame is a silicon frame.

19. The keypad input system of claim 12, further comprising:
an RFID tag attached to said frame comprising keypad information; and
an RFID reader in said housing and connected to said processor, for reading said keypad information when said frame is placed on the outer surface of said housing around said touch-sensitive panel, and for transmitting said keypad information to said processor.

20. The keypad input system of claim 19, comprising a plurality of different frames that are alternately temporarily placed over said touch-sensitive panel, each frame having an attached RFID tag identifying which of the plurality of frames it is.

21. The keypad input system of claim 20, wherein said plurality of different frames comprise a frame for a copier, a frame for a scanner and a frame for a fax.

22. The keypad input system of claim 20, wherein each of said plurality of different frames comprises a braille label identifying which of the plurality of frames it is.
